(19) United States
(12) Patent Application Publication
(10) Pub. No.: US 2018/0002871 A1
(43) Pub. Date: Jan. 4, 2018

(54) SPREADING APPARATUS

(71) Applicant: REDEXIM HANDEL- EN EXPLOITATIE MAATSCHAPPIJ B.V., AC Zeist (NL)

(72) Inventor: Uli BACHMANN, Amtzell (DE)

(73) Assignee: REDEXIM HANDEL- EN EXPLOITATIE MAATSCHAPPIJ B.V., AC Zeist (NL)

(21) Appl. No.: 15/543,671

(22) PCT Filed: Nov. 13, 2015
(86) PCT No.: PCT/EP2015/076569

§ 371 Date: Jul. 14, 2017

(30) Foreign Application Priority Data
Jan. 16, 2015 (DE) 20 2015 000 189.0

(51) Int. Cl. E01C 19/20; B05B 3/10; B05B 9/00; E01H 10/00

(52) U.S. Cl. CPC E01C 19/203; B05B 9/007; B05B 3/1007; E01H 10/007; E01C 2019/2055

(57) ABSTRACT

In a spreading apparatus for scattering spreading material, in particular sand or soil substrates, onto a ground surface, includes a container for the spreading material and at least one spreading unit by which the spreading material in the container can be scattered, wherein the spreading unit includes at least one rotatable spreading disc which is substantially parallel to the ground and at least one drive device for rotating the spreading disc about the axis of rotation with the result that the spreading material can be scattered by the spreading disc and by virtue of centrifugal forces, provision is made for a limiting device to be arranged in at least part of the circumferential region of the spreading disc, which limiting device prevents the scattering of the spreading material in this part of the circumferential region, wherein the position of the limiting device relative to the spreading disc is adjustable, with the result that the direction in which the spreading material can be scattered is variable.

The invention relates to a spreading apparatus for scattering spreading material, in particular sand or soil substrates, onto a ground surface, in particular on golf courses, according to the precharacterizing part of claim 1.

Previously known spreading apparatus for scattering spreading material, in particular onto golf courses, comprise a container for the spreading material and at least one spreading unit by means of which the spreading material in the container is adapted to be scattered. The spreading unit in most cases comprises a rotatable spreading disc which is substantially parallel to the ground. Further, in most cases a drive device for rotating the spreading disc about the axis of rotation is provided. Such rotation of the spreading disc and centrifugal forces can cause the spreading material to be scattered by means of the spreading disc.

Such spreading apparatus are frequently used on golf courses and grass courses. Here, the problem arises that on some grass fields the spreading material is intended to be scattered only in one specific direction. Further, on golf courses it is frequently required to fill bunkers, for example, with the aid of such apparatus without scattering material onto the surrounding grass.

It is therefore an object of the invention to provide a spreading apparatus which is capable of scattering material in a defined region.

This object is achieved with the features of claim 1.

According to the invention a limiting device is advantageously arranged in at least a portion of the circumferential region of the spreading disc and prevents scattering of the spreading material in this portion of the circumferential region, wherein the position of the limiting device relative to the spreading disc is adjustable such that the direction in which the spreading material is scatterable is variable.

In this manner the spreading material can be scattered in a defined direction.

Thus bunkers on a golf course can be filled without the spreading material being scattered onto the surrounding grass. Further, the spreading material can be merely scattered onto specific regions of the ground surface.

The scattering disc can be rotatable about an axis of rotation, wherein the limiting device is pivotable about the pivoting axis such that the limiting device is adapted to be placed in different circumferential regions of the spreading disc.

When the limiting device is adjusted, the spreading width at which the spreading material is adapted to be scattered can remain constant. Thus merely the direction in which the spreading material is scattered is varied and not the spreading width. The spreading width is to be understood as the width of the ground surface onto which the spreading material is scattered when the spreading apparatus travels across said surface once.

A linear motor can be connected with the limiting device and a housing element of the spreading unit and adjust the limiting device. The linear motor can be electrically, hydraulically or pneumatically operated.

The drive device for rotating the spreading disc may also be an electric, hydraulic or pneumatic drive device.

At least one paddle element can be substantially radially arranged on the spreading device.

The limiting device may be higher in a direction parallel to the axis of rotation than the paddle elements arranged on the spreading disc. In this manner it is ensured that the spreading material is not inadvertently thrown over the limiting device.

The limiting device may be a sheet metal element.

The limiting device configured as a sheet metal element may comprise a sheet metal edge projecting towards the spreading disc at the upper and lower free ends, wherein the lower projecting sheet metal edge is arranged beneath the spreading disc. The limiting device may have a bent configuration and be matched to the shape of the outer circumference of the spreading disc.

The limiting device may be arranged at a defined distance to the spreading disc, wherein the distance of the limiting device to the spreading disc is preferably less than 1 cm, in particular less than 0.5 cm. The spreading apparatus may be self-propelled or towable by a towing vehicle.

A spreading apparatus may be provided which controls the adjustment of the limiting device and thus the direction in which the spreading material is scatterable.

The control device may control the adjustment of the limiting device as a function of the transport direction of the spreading apparatus.

The control device may control the adjustment of the limiting device as a function of the steering direction of the self-propelled spreading apparatus or the towing vehicle.

The spreading apparatus may comprise a single spreading disc.

A refill device may be provided by means of which the spreading material is adapted to be transferred from the container to the spreading disc, wherein the amount of the spreading material per time is preferably meterable by means of the refill device.

Hereunder exemplary embodiments of the invention are described in detail with reference to the drawings in which

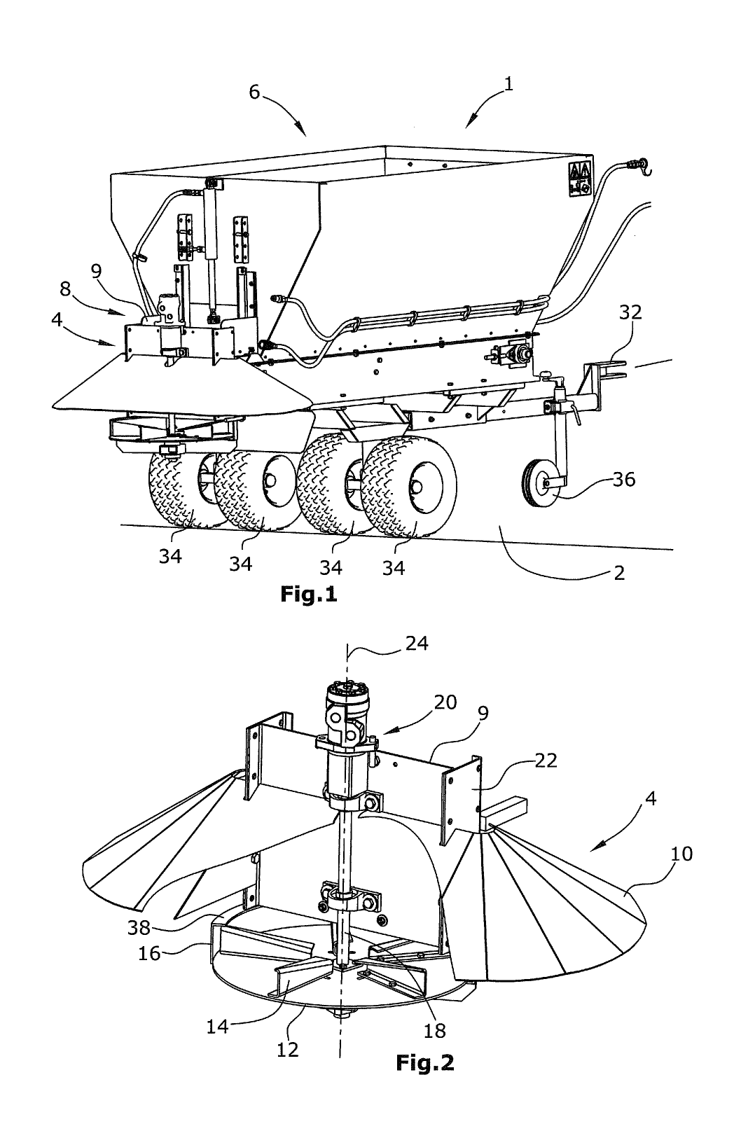

FIG. 1 schematically shows a spreading apparatus according to the present invention,

FIG. 2 schematically shows a spreading unit according to the present invention,

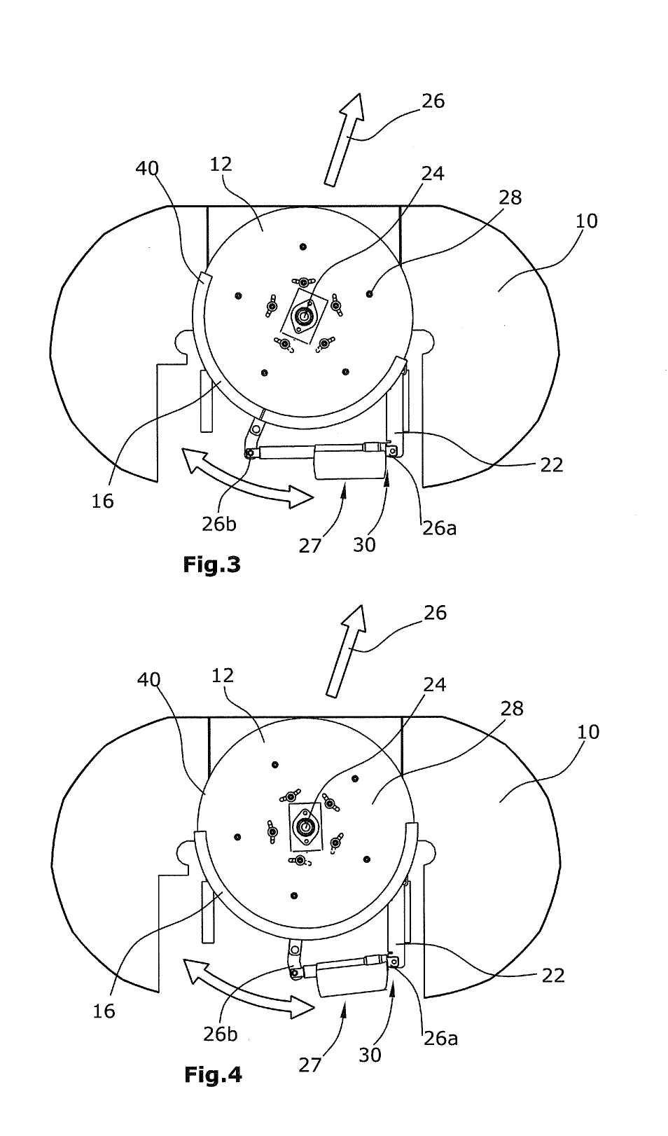

FIG. 3 schematically shows a top view of the spreading unit according to FIG. 2, and

FIG. 4 schematically shows a spreading unit according to FIGS. 2 and 3 with the limiting device being adjusted.

FIG. 1 shows a spreading apparatus 1 for scattering spreading material. In FIG. 1 a spreading apparatus 1 is shown which can be towed by a towing vehicle. The spreading apparatus 1 comprises a coupling device 32 for being coupled to a towing vehicle. Alternatively, the spreading apparatus may be self-propelled.

The spreading apparatus 1 comprises a container 6 for the spreading material and at least one spreading unit 4 by means of which the spreading material included in the container 6 is adapted to be scattered. Preferably, a refill device 8 is provided by means of which the spreading material is transferrable from the container 6 to the spreading unit 4.

Preferably, the spreading apparatus 1 comprises more than two wheels 34 by means of which the spreading apparatus 1 is movable on the ground surface 2. When more than two wheels 34 are provided the weight which is exerted onto the ground surface 2 by the spreading apparatus 1 loaded with the spreading material is more uniformly distributed. In the present case the spreading apparatus 1 comprises four wheels 34. Further, the spreading apparatus 1 comprises a transport wheel 36 which however, in a state in which the spreading apparatus is connected to a towing vehicle, is retracted and not in contact with the ground surface 2.

The spreading unit 4 is shown in detail in FIGS. 2 to 4. The spreading unit 4 comprises a rotatable spreading disc 12 which is substantially parallel to the ground and preferably rotatable about an axis of rotation 24 which is substantially orthogonal to the ground surface 2. As in the present case, the axis of rotation 24 may be a purely imaginary axis and not a component. At the spreading disc 12 at least one paddle element 14 is substantially radially arranged. A plurality of paddle elements 14 may arranged at the spreading disc 12.

At least one drive device 20 for rotating the spreading unit 12 about the axis of rotation 24 is provided such that the spreading material is scatterable by means of the spreading disc 12 and by virtue of centrifugal forces. The drive device 20 comprises a shaft 18 which is connected with the spreading disc 12 and drives the spreading disc. The drive device 20 is supported in a housing element 22. Further, at the housing element 22 a shielding device 10 is arranged which prevents the spreading material from being ejected in upward direction.

The spreading material can be scattered by rotating the spreading disc 12 by means of the drive device 20. By virtue of the centrifugal force the spreading material moves into the outer region of the spreading disc 12 and is ejected there.

The spreading unit 4 further comprises a limiting device 16 which is arranged at least in a portion of the circumferential region of the spreading disc 12 and limits the scattering of the spreading material in this portion of the circumferential region. The spreading material can thus only be scattered in the direction which is not limited by the limiting device.

The position of the limiting device 16 is adjustable relatively to the spreading disc 12 such that the direction in which the spreading material is scatterable is variable. The fact that the limiting device 16 is adjustable relatively to the spreading disc 12 means that the limiting device 16 is placeable in different circumferential regions of the spreading disc. The limiting device 16 is preferably pivoted about the axis of rotation 24 such that the limiting device 16 is placeable in different circumferential regions of the spreading disc.

By adjusting the position of the limiting device the direction in which the spreading material is scattered can be adjusted. On a golf course the spreading apparatus 1 can thus be used as a refill device for a bunker without the spreading material being scattered onto the surrounding grass. Alternatively, grass fields along a path can be provided with spreading material without the path being covered by the spreading material.

In FIGS. 3 and 4 it can be seen how the limiting device 16 can be adjusted. In FIGS. 3 and 4 the spreading apparatus 4 is illustrated from below.

As in the illustrated exemplary embodiment, the limiting device 16 can be a sheet metal element. The limiting device 16 configured as a sheet metal element may comprise at the upper and lower free ends a sheet metal edge 38, 40 projecting towards the spreading disc, wherein the lower protruding sheet metal edge 40 is arranged beneath the spreading disc 12. In this manner spreading material is prevented from being inadvertently discharged in upward or downward direction.

As in the illustrated exemplary embodiment, the limiting device 16 may have a bent configuration and be matched to the shape of the outer edge of the spreading disc 12. The limiting device 16 may be arranged at a defined distance to the spreading disc 12, wherein the distance from the limiting device 16 to the spreading disc 12 is preferably less than 1 cm, in particular less than 0.5 cm. In this manner the spreading disc 12 can be smoothly rotated, and it can nevertheless be prevented that too much spreading material drops down between the limiting device 16 and the spreading disc 12 and onto the ground surface 2.

In FIGS. 3 and 4 an adjusting device 27 is illustrated by means of which the limiting device 16 is adjustable. As in the illustrated exemplary embodiment, the adjusting device 27 may be a linear motor 26. At the first end 26a the linear motor 26 is connected with the housing element 22 of the spreading unit 4 and at the second end 26b it is connected with the limiting device 16. By adjusting the linear motor 26 the position of the limiting device 16 relative to the spreading disc 12 can be adjusted.

In FIG. 4 a state is illustrated in which the linear motor 26 is retracted and the limiting device 16 is adjusted as compared with FIG. 3.

A control device 30 may be provided which controls the adjustment of the limiting device 16 and thus the direction in which the spreading material is ejectable ejected. The control device 30 can control the adjustment of the limiting device 16 as a function of the transport direction of the spreading apparatus. The control device 30 can control the adjustment of the limiting device 16 as a function of the steering direction of the towing vehicle. Further, a person operating the towing vehicle can operate the control device 30 and thus control the limiting device 16.

Preferably, the spreading unit 4 comprises only a single spreading disc 12.

In the spreading apparatus 1 the spreading width at which the spreading material is adapted to be scattered preferably remains constant when the limiting device 16 is adjusted. Merely the direction in which the spreading material is ejected is adjusted. The spreading width is the width on the ground surface onto which the spreading material is scattered when the spreading apparatus travels across said surface once.

The refill device 8 preferably meters out the amount of spreading material which is supplied to the spreading disc. The spreading material preferably drops through the feeder 9 onto the spreading disc 12.

1-15. (canceled)

16. A spreading apparatus for scattering spreading material, in particular sand or soil substrates, onto a ground surface, having a container for the spreading material and at least one spreading unit by means of which the spreading material included in said container is scatterable, wherein said spreading unit comprises:
at least one rotatable spreading disc which is substantially parallel to the ground,
at least one drive device for rotating said spreading disc about the axis of rotation such that the spreading material is scatterable by means of said spreading disc and by virtue of centrifugal forces, wherein a limiting device is arranged at least in a portion of the circumferential region of said spreading disc which prevents the spreading material from being scattered in this portion of the circumferential region, wherein the position of said limiting device relative to said spreading disc is adjustable such that the direction in which the spreading material is scatterable is variable.

17. The spreading apparatus according to claim 16, wherein the spreading disc is rotatable about an axis of rotation, wherein the limiting device is pivotable about said axis of rotation such that said limiting device is placeable in different circumferential regions of said spreading disc.

18. The spreading apparatus according to claim 16, wherein during adjustment of the limiting device the spreading width at which the spreading material is scatterable remains constant.

19. The spreading apparatus according to claim 16, wherein a linear motor is connected with the limiting device and a housing element of the spreading device and adjusts said limiting device.

20. The spreading apparatus according to claim 17, wherein at least one paddle element is substantially radially arranged on the spreading disc, wherein the limiting device is preferably higher in one direction parallel to the axis of rotation than said paddle element arranged on said spreading disc.

21. The spreading apparatus according to claim 16, wherein the limiting device is a sheet metal element.

22. The spreading apparatus according to claim 21, wherein the limiting device configured as a sheet metal element comprises at the upper and lower free ends a sheet metal edge protruding towards the spreading disc, wherein the lower protruding sheet metal edge is arranged beneath said spreading disc.

23. The spreading apparatus according to claim 16, wherein the limiting device has a bent configuration and is matched to the shape of the outer edge of the spreading disc.

24. The spreading apparatus according to claim 16, wherein the limiting device is arranged at a defined distance to the spreading disc, wherein the distance from said limiting device to said spreading disc preferably is less than 1 cm, in particular less than 0.5 cm.

25. The spreading apparatus according to claim 16, wherein said spreading apparatus is self-propelled or towable by a towing vehicle.

26. The spreading apparatus according to claim 16, wherein a control device is provided which controls the adjustment of the limiting device and thus the direction in which the spreading material is ejectable.

27. The spreading apparatus according to claim 26, wherein the control device controls the adjustment of the limiting device as a function of the transport direction of said spreading apparatus.

28. The spreading apparatus according to claim 26, wherein the control device controls the adjustment of the limiting device as a function of the steering direction of said self-propelled spreading apparatus or the towing vehicle.

29. The spreading apparatus according to claim 16, wherein only a single spreading disc is provided.

30. The spreading apparatus according to claim 16, wherein a refill device is provided by means of which the spreading material is transferable from the container to the spreading disc, wherein the amount of the spreading material per time is meterable by means of the refill device.
